(19) United States
(12) Patent Application Publication
(10) Pub. No.: US 2023/0212880 A1
(43) Pub. Date: Jul. 6, 2023

(54) LOCK

(71) Applicant: FULLYEAR-BROTHER ENTERPRISE CO., LTD., CHANGHUA COUNTY (TW)

(72) Inventor: Chun Te YU, CHANGHUA COUNTY (TW)

(21) Appl. No.: 17/885,074

(22) Filed: Aug. 10, 2022

(30) Foreign Application Priority Data
Dec. 30, 2021 (TW) 110149775

(51) Int. Cl. E05B 37/02; E05B 67/00

(52) U.S. Cl. CPC E05B 37/025; E05B 67/003

(57) ABSTRACT

The present invention discloses a combination lock mechanism for a lock, it includes a plurality of dials and an elastic member, each dial has a plurality of blocks and a plurality of grooves, each block has an identification element respectively, each groove is located between two adjacent blocks, the elastic member is located beside the combination mechanism and having a basic sheet and plurality of elastic sheets, each elastic sheet is connected to a side of the basic sheet, and each elastic sheet has a protruding portion on both ends respectively, each protruding portion can be lodged into each groove of the dial.

### BACKGROUND OF INVENTION

### Field of Invention

The present invention relates to a luggage lock, more particularly, to an elastic component inside of a lock and a key lock mechanism.

### Related Prior Art

In recent years, to meet the customs inspections requirements, a lock with dual-lock mechanisms had become common. This type of lock usually includes a key lock mechanism, a combination lock mechanism and an elastic member. The key lock mechanism allows the customs officer to operate the lock, and the combination lock mechanism allows a user to operate the lock, and both operations enable the lock to be opened or locked. The elastic member is pressed against the dials of the combination lock mechanism so that rotations of each of the dials would not come loose, and each of the dials is further positioned whenever a number is shifted. User can obtain the positioning sense when turning the dials.

However, there is a need for the aforementioned lock mechanism to be improved and enhanced.

### SUMMARY OF THE INVENTION

The present invention provides a lock, where a combination lock mechanism includes a plurality of dials and an elastic member, each dial has a plurality of blocks and a plurality of grooves, each block having an identification element respectively, and each groove is respectively located between two adjacent blocks, the elastic member is located on the side of the combination lock mechanism and includes a base sheet and a plurality of elastic sheets, each elastic sheet is connected to a side of the base sheet, each of the two ends of the elastic sheet has an protruding portion, and each protruding portion is able to be lodged into each groove of the dial.

In one embodiment, the base sheet and the elastic sheets of the lock of the present invention are one piece.

In another embodiment, each elastic sheet of the lock of the present invention protrudes from the base sheet and forms an arc shape.

In a more detailed embodiment, the present invention provides another type of lock comprises a housing, a cable, a key lock core and a driving member. The housing includes a first shell, the first shell having two holes. Each of the holes includes a first hole portion with a first width and a second hole portion with a second width. The first width is less than the second width. The first hole portion is in communicate with the second hole portion. The cable includes a cable cord and two connecting portions, each connecting portion has an upper-section, a lower-section and a mid-section between the upper-section and the lower-section, the two upper-sections are connected to the two terminal ends, each respective lower-section is able to only enter and exit the second hole portion, but not the first hole portion, each mid-section is able to enter and exit the second hole portion, and move from the second hole portion into the first hole portion, and move from the first hole portion to the second hole portion. The key lock core can be rotated by a key. The driving member includes a blocking portion, an extension rod, a coupling portion and a push portion, the coupling portion is coupled to the key lock core, so that when the key lock core is rotated, the coupling portion, the extension rod and the blocking portion all rotate simultaneously, so that the blocking potion will leave a block position and no longer blocks one of the lower-section from moving toward a direction, and when the key lock core is rotated, the push portion will be driven to a push position and thereby pushing the lower-section towards the direction of the push position.

In one embodiment, one end of the push portion of the lock of the present invention is tapered.

### BRIEF DESCRIPTION OF THE DRAWINGS

FIG. 1 is an exploded view of the padlock in accordance with a preferred embodiment of the present invention;

FIG. 2 is a top view of a lock housing 1 in accordance with the preferred embodiment of the present invention;

FIG. 3 is a perspective view of the preferred embodiment of the present invention;

FIG. 4 shows the preferred embodiment of the present invention with the housing 1 being ripped;

FIG. 5 is a perspective view of a twistable cable 21 being twisted to form an X-shaped cross state in accordance with the preferred embodiment of the present invention;

FIG. 6 is a cross-sectional view of the preferred embodiment of the present invention in FIG. 5 with the housing 1 being ripped;

FIG. 7 is a perspective view of an elastic sheet in accordance with the preferred embodiment of the present invention;

FIG. 8 is a side view of the elastic sheet 42 in accordance with the preferred embodiment of the present invention;

FIG. 9 is a top view of the elastic sheet 42 operating with a dial 32 in accordance with the preferred embodiment of the present invention;

FIGS. 10 to 12 show schematic views of the operation of locking and unlocking of the lock with a plurality of dials 32 in accordance with the preferred embodiment of the present invention;

FIGS. 13 to 15 show schematic views of the operation of locking and unlocking of the lock with a key 6 in accordance with the preferred embodiment of the present invention.

### DETAILED DESCRIPTION

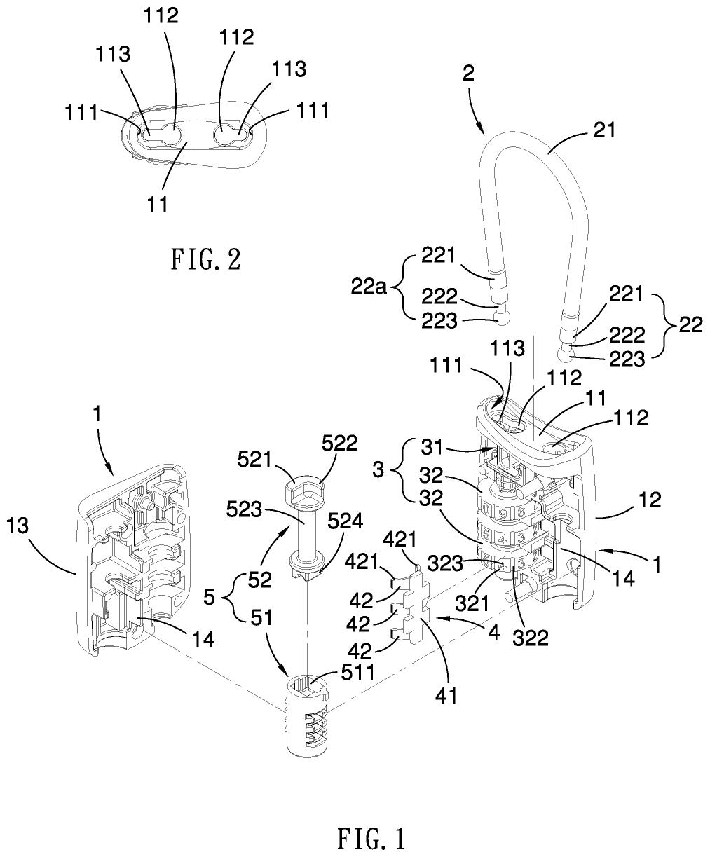

FIG. 1 is a preferred embodiment of the lock of the present invention, in this embodiment, the present invention is a cable lock. However, some of the components described herein may be applied to other type of locks, and not limited to cable locks.

As described in FIGS. 1 and 2, the cable lock includes a housing 1, and a locking member, in this embodiment, the locking member can be a cable 2, but it can also be a U-shaped shackle, or in other form. In any event, the locking member is used to go through an object, and the object could be a zipper on a luggage, a keyhole on a laptop, a door latch or any object that requires locking.

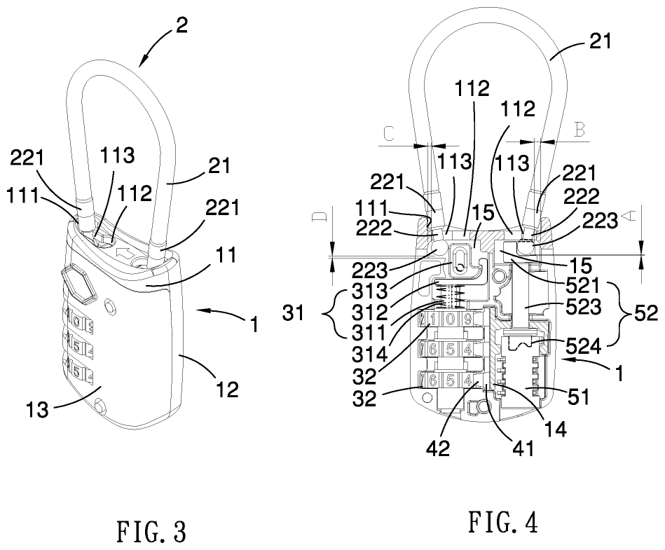

In this embodiment, the housing 1 includes a first shell 11. The first shell 11 has two holes. Each of the holes includes a first hole portion 113 with a first width and a second hole portion 112 with a second width. The first width is less than the second width. The first hole portion 113 is in communication with the second hole portion 112, and they are aligned along the length of the first shell 11. In this preferred embodiment, the two second hole portions 112 are located between the two first hole portions 113, but the two first hole portions 113 could also be switched to be located between the two second hole portions 112. In this preferred embodiment, the housing 1 further includes a second shell 12 and a third shell 13. The second shell 12 is extended downward from the first shell 11, and the second shell 12 is integrally formed with the first shell 11, that is, that they are one piece. As shown in FIG. 3, the third shell 13 engages with the second shell 12 and the first shell 11, so that these three shells 11, 12 and 13 together define an inner space, for accommodating a part of or all of the components described herein. Two accommodating cavities 15 are respectively provided below the holes in the housing 1.

The cable 2 includes a twistable cable cord 21 and two connecting portions 22. The twistable cable cord 21 is preferably made of a steel cable, and the outside of the steel cable is usually covered with a layer of wear-resistant plastic. Each connecting portion 22 includes an upper-section 221, a lower-section 223, and a mid-section 222 located between the upper-section 221 and the lower-section 223. The mid-section 222 is cylindrical and has a diameter less than both the first and second widths of the first and second hole portions 112, 113. The lower-section 223 is spherical and has a diameter between the first and second widths of the first and second hole portions 112, 113. The two upper-sections 221 are respectively connected to two terminal ends of the twistable cable cord 21. Each lower-section 223 is only able to pass through the second hole portion 112 so as to enter and exit the accommodating cavity 15, but fails to pass through the first hole portion 113. Each mid-section 222 is able to pass through the second hole portion 112, and is able to move from the second hole portion 112 into the first hole portion 113, and to move from the first hole portion 113 into the second hole portion 112. Wherein, when the two lower-sections 223 of the cable 2 respectively enter into the two accommodating cavities 15 and move into the underside of the two first hole portions 113, the second shell 12 and the connecting portions 22 of the cable 2 are thus connected, as shown in FIGS. 3 and 4, and at this point, the twistable cable cord 21 of the cable 2 is twisted to form an U-shape.

As shown in FIGS. 3 and 4, the first shell 11 further comprises two upper walls 111 that protrude upwards and are opposite to each other. Through the elastic force accumulated when the twistable cable cord 21 is bent, the two connecting portions 22 of the cable 2 in U-shape is inclined at an angle, so that the upper-section 221 of each of the connecting portion 22 respectively leans against the two upper walls 111 of the first shell 11.

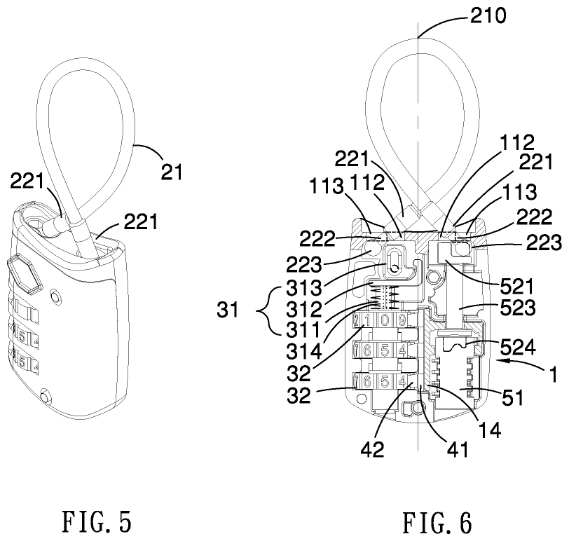

Furthermore, the twistable cable cord 21 of the cable 2 in U-shape can be twisted into an X-shaped cross state, and remain in that X-shaped cross state, as shown in FIGS. 5 and 6. At this time, by twisting the twistable cable cord 21 reversely, the cable 2 can be restored to U-Shape.

As shown in FIGS. 5 and 6, when the twistable cable cord 21 is in an X-shape cross state, the two upper-sections 221 respectively lean into the two second hole portion 112 from top of the two first hole portion 113, and inclined at different directions. Wherein, the two upper-sections 221 respectively cover the entire two second hole portion 112, and each leans against the edge of the two second hole portion 112. However, the two upper-sections 221 can also covers part of the two second hole portion 112. In addition, one of the upper-section 221 may cover the entire corresponding second hole portion 112, while the other upper-section 221 covers part of the corresponding second hole portion 112.

When the twistable cable cord 21 is in X-shaped state, a cross point of the twistable cable cord 21 is farther away from an apex 210 of the twistable cable cord 21, and closer to the two connecting portions 22.

As shown in FIG. 2, the two second hole portions 112 are of the same size, whereas one of the two first hole portions 113 is longer in length than the other. When the twistable cable cord 21 in X-shape state, the cross point of the twistable cable cord 21 is closer to the first hole portion 113 with the smaller length, and farther away from the first hole portion 113 with the longer length. In this embodiment, the length of the first hole portion 113 on the left is greater than the length of the first hole portion 113 on the right, hence, the cross point of the twistable cable cord 21 is closer to the first hole portion 113 on the right, and farther away from the first hole portion 113 on the left.

In any case, the aforementioned twistable cable cord 21 can be twisted into X-shape, indicating that the twistability of the entire cable 2 is high, allowing it to be flipped and twisted along with the housing 1.

As shown in FIG. 1, the cable lock of the present invention further includes a lock mechanism, for locking the two connecting portions 22 disposed inside the housing 1, as shown in FIGS. 3 and 4. In the preferred embodiment, the lock mechanism includes a combination lock mechanism 3 and a key lock mechanism 5, but not limited thereto, for example, the lock mechanism may only have a combination lock mechanism, or one key lock mechanism, or two combination lock mechanisms or two key lock mechanisms. In a preferred embodiment, the combination lock mechanism 3 can be locked or unlocked by a user (such as the owner of the cable lock) to determine whether one of the connecting portions 22 can be pulled away from the housing 1. The key lock mechanism 5 can be locked or unlocked by another user (such as a customs luggage inspector) to determine whether the other one of the connecting portions 22 can be pulled away from the housing 1.

As shown in FIGS. 1 and 4, the combination lock mechanism 3 is located within the housing 1, to lock or unlocked a connecting portion 22 of the cable 2. In a preferred embodiment, the combination lock mechanism 3 includes a plurality of dials 32 exposed from the housing, and each dial 32 has a plurality of blocks 321 and a plurality of the grooves 322, each block 321 has an identification element 323 respectively, and each groove 322 is located between the two adjacent blocks 321. Each identification element 323 is preferably a number, a letter or a symbol.

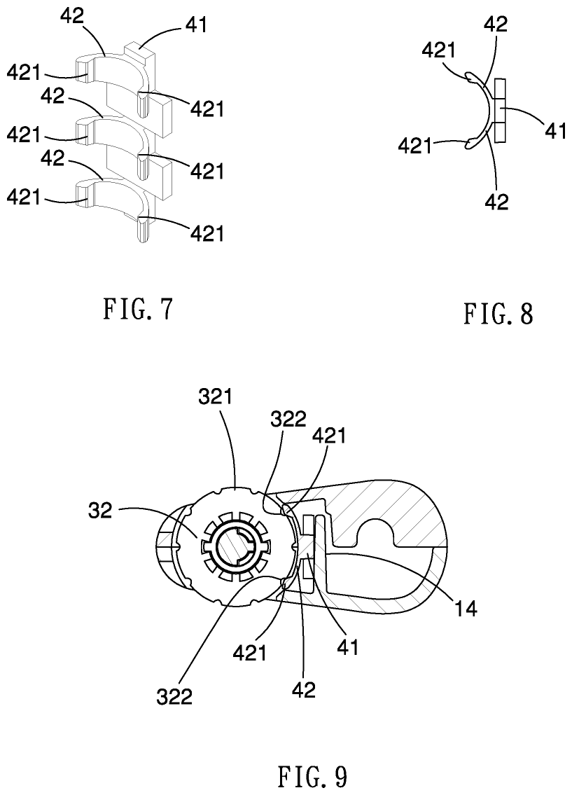

In the preferred embodiment, the combination lock mechanism 3 further comprises an elastic member 4 located within the housing 1, it is located beside the combination lock mechanism 3 and includes a base sheet 41, and a plurality of elastic sheets 42. The base sheet 41 and the elastic sheets 42 are integrally formed, that is, they are of one piece, and they are preferably made of plastic material with high elasticity and high wear resistance (durability), wherein, a back side of the base sheet 41 is leaning against a wall 14 of the housing 1, and each elastic sheet 42 protrudes forward from the base sheet 41 and forms an arc shape, and each of the two ends of the elastic sheet 42 has a protruding portion 421 respectively. As shown in FIG. 7, each protruding portion 421 can be lodged into the groove 322 of the dial 32, to provide a resistance to the dial 32, to keep it tight, meaning, the dial could be turned but not randomly rotated, moreover, user can obtain a positioning sense for a better experience when turning the dials.

The combination lock mechanism 3 further comprises a lock assembly 31 located within the housing 1, a correct combination or an incorrect combination can be dialed by the dials 32, to determine whether the lock assembly 31 will enter into a movable state or a non-moving state. That is to say, FIGS. 3 to 6 show the combination lock mechanism 3 in a locked state, at this time, the dial 32 shows an incorrect combination so that the lock assembly 31 is in a non-moving state, thus, the lower-section 223 is blocked by a blocking member 313 and unable to move towards the second hole portion 112 on the right as shown in the figure, so that the lower-section 223 is still restricted by the housing in the underside of the first hole portion 113 on the right as shown in the figure, unable to be pulled away from the housing 1. Even though the lower-sections 223 are restricted, the lower-sections 223 are not firmly fixed in the corresponding accommodating cavities 15 since gaps A, B, C, D are provided as shown in FIG. 4. Wherein, the blocking member 313 is usually located at a blocking position at the underside of the second hole portion 112 on the right as shown in the figure, and it could be pushed to the right or downward to leave away from the blocking position.

FIGS. 8 to 10 show the combination lock mechanism 3 in an unlocked state, the dial 32 shows a correct combination so that the lock assembly 31 is in a movable state, thus, the lower-section 223 of one of the connecting portions 22 of the cable 2 is able to move towards the second hole portion 112. Once the lower-section 223 moves toward the second hole portion 112, it will push the blocking member 313 to move away from the underside of the second hole portion 112, as shown in FIG. 8, at this time, the lower-section 223 is able to move from the underside of the first hole portion 113 to the underside of the second hole portion 112, and to pull away from the housing 1 from the second hole portion 112. When the blocking member 313 is moving in a way as aforementioned, it will also push a supporting member 312 of the lock assembly 31 downward, so that a shaft 311 connected to the bottom of the supporting member 312 will also move downward, and thus compressed a spring 314. Once the lower-section 223 is pulled away from the housing 1, the compressed spring 314 will spring upward to push the supporting member 312, which cause the entire lock assembly 31 to return to its original position immediately, as shown in FIG. 9.

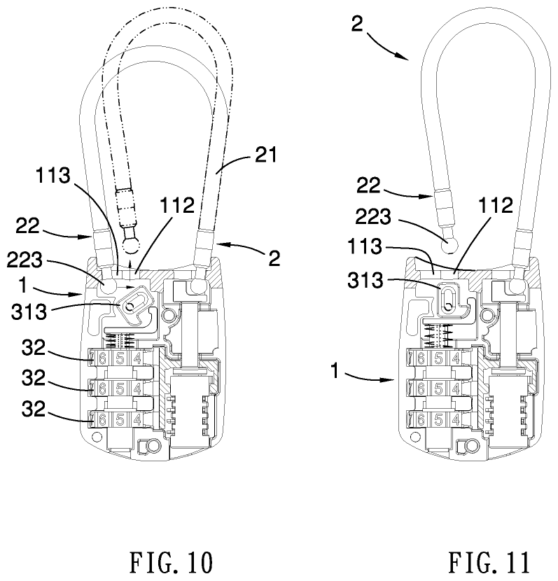

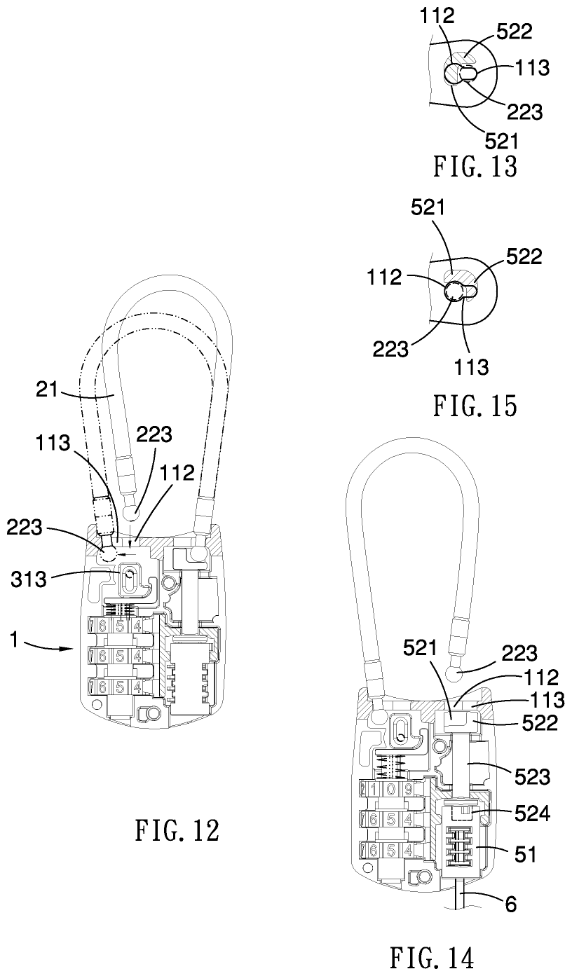

FIG. 10 shows the lower-section 223 being inserted into the second hole portion 112 and pressed down the blocking member 313 to move downward, and moves into the underside of the first hole portion 113 from the underside of the second hole portion 112 through the elasticity of the cable 21 itself, then the entire lock assembly 31 will return to its original position immediately through the compressed spring 314, and then, when the dial 32 is dialed with incorrect combination, the entire cable lock will be in a locked state as shown in FIG. 6, so that the lower-section 223 cannot pull away from the housing 1.

As shown in FIGS. 1 and 4, the key lock mechanism 5 is located within the housing 1, and is used to lock or unlock the other connecting portion 22 of the cable 2. In a preferred embodiment, the key lock mechanism 5 includes a key lock core 51 and a driving member 52 all located within the housing 1, a bottom portion of the key lock core 51 is exposed from the housing 1 and has a key hole (not shown), as shown in FIG. 14, when a legitimate key 6 is inserted into the key hole, it is able to rotate the key lock core 51. The driving member 52 includes a blocking portion 521, a push portion 522, an extension rod 523 and a coupling portion 524, they are preferably made in one piece. The blocking portion 521 and the push portion 522 are disposed at an end of the extension rod 523, and further the blocking portion 521 is connected with the push portion 522 at an angle about 90 degrees. The blocking portion 521 and the push portion 522 respectively located at two sides of the lower-section 223. Wherein, the coupling portion 524 is coupled to the key lock core 51, so that when the key lock core 51 is rotated it will drive the coupling portion 524 to rotate as well, and the extension rod 523 that is connected to the coupling portion 524 will also rotate, and thus drive the blocking portion 521 and the push portion 522 that are connected to the extension rod 523 to rotate as well. In addition, a top of the key lock core 51 is preferably formed with a coupling hole 511 with multiple sides, such as quadrilateral coupling hole 511. The coupling portion 524 is shaped corresponding to the coupling hole 511, so that it can be coupled to the coupling hole 511.

FIGS. 4 to 6 show a key lock mechanism 5 in a locked state, where the blocking portion 521 of the key lock mechanism 5 blocks the lower-section 223 of the connecting portion 22 of the cable, so that the lower-section 223 cannot move towards the second hole portion 112, thus, the lower-section 223 is still retained by the housing 1 in the underside of the corresponding first hole portion 113, and unable to pull away from the housing 1. At this time, as shown in FIG. 13, the push portion 522 is located beside the blocking portion 521 and not blocking the lower-section 223.

When the key lock core 51 is turned to a locked position by a legitimate key 6 as shown in FIG. 4 to a unlocked position as shown in FIG. 14, as the coupling portion 524 and the extension rod 523 are rotated simultaneously, the blocking portion 521 will move from a blocking position as shown in FIG. 13 to an unblocking position as shown in FIG. 15, and in the process push the lower-section 223 away from the underside of the first hole portion 113 towards the second hole portion 112, and then it can be pulled away from the housing 1 from the second hole portion 112, and at this point, the key lock core 51 is in an unlock state, and no longer locks the lower-section 223.

When the lower-section 223 is inserted into the second hole portion 112, and moves into the underside of the first hole portion 113 from the underside of the second hole portion 112 through the elasticity of the cable 21 itself By reversing the key 6 to drive the key lock core 51 from an unlocked position to a locked position, the entire driving member 52 is driven to return to its original position, at this time, the entire cable lock will be in a locked state as shown in FIG. 6, so that the lower-section 223 cannot be pulled away from the housing 1.

It is worth noting that the aforementioned key lock mechanism 5 can be used independently in a lock, the combination lock mechanism 3 and elastic member 4 can also be used independently in another lock, and these locks may be in a single lock form, as well as a dual lock form.

What is claimed is:

1. A lock comprising:
a locking member, used to go through an object;
a combination lock mechanism, for controlling the movement of the locking member, including a plurality of dials and an elastic member, each dial having a plurality of blocks and a plurality of grooves, each block having an identification element respectively, each groove being located between two adjacent said blocks, the elastic member including a base sheet and a plurality of elastic sheets respectively connected to a side of the base sheet, the elastic sheets abutting against the dials one by one, each of two ends of each elastic sheet being provided with a protruding portion capable of lodging into one said groove of the corresponding dial.

2. A lock as recited in claim 1, wherein each of the elastic sheets is arc-shaped and extends away from the base sheet.

3. A lock as recited in claim 1, wherein the base sheet and the elastic sheets are integrally formed.

4. A lock as recited in claim 3, wherein each of the elastic sheets is arc-shaped and extends away from the base sheet.

5. A lock, comprising:
a housing with two holes, each of the holes including a first hole portion with a first width and a second hole portion with a second width, the first hole portion being laterally connected to the second hole portion, the first width being less than the second width, wherein two accommodating cavities are respectively provided below the holes in the housing;
a cable having a cable cord with two connecting portions respectively disposed at two terminal ends of the cable cord, each connecting portion having an upper-section connected to the terminal end of the cable cord, a lower-section and a mid-section between the upper-section and the lower-section, the lower-section being able to pass through the second hole portion so as to enter and exit the accommodating cavity but failing to pass through the first hole portion, the mid-section being able to pass through the second hole portion and moving back and forth within the first and second hole portion;
a key lock core located in the housing, rotatable by a key; and
a driving member located in the housing and being connected to the key lock core, the driving member including a blocking portion and a push portion respectively located at two sides of the lower-section of one of said connecting portions, the blocking portion and the push portion moving around the lower-section as a result of rotation of the key lock core, the blocking portion blocking the lower-section so that the connecting portion cannot move from the first hole portion toward the second hole portion when the key lock core is rotated to a lock position, the blocking portion failing to block the lower-section, along with the push portion pushing the lower-section, so that the connecting portion moves from the first hole portion toward the second hole portion when the key lock core is rotated to an unlock position.

6. A lock as recited in claim 5, wherein the mid-section of the connecting portion is cylindrical and has a diameter less than both the first and second widths of the first and second hole portions; the lower-section of the connecting portion is spherical and has a diameter between the first and second widths of the first and second hole portions.

7. A lock as recited in claim 5, wherein one end of the push portion is tapered.

8. A lock as recited in claim 5, wherein the blocking portion is connected with the push portion at an angle about 90 degrees.

9. A lock as recited in claim 5, wherein the driving member further includes an extension rod coupled to the key lock core, and the blocking portion and the push portion are disposed at an end of the extension rod.

10. A lock as recited in claim 9, wherein a polygon coupling hole is provided on the key lock core for a coupling portion of the extension rod in a complementary shape to be inserted into.

11. A lock as recited in claim 5, wherein each of the lower-sections of the connecting portions is not firmly fixed in the corresponding accommodating cavity when the key lock core is rotated to the lock position.
